(19) United States
(12) Patent Application Publication
(10) Pub. No.: US 2018/0057143 A1
(43) Pub. Date: Mar. 1, 2018

(54) AIRFOIL EXTENSION FOR AN AIRCRAFT WING

(71) Applicant: AIRBUS (S.A.S.), Toulouse Cedex (FR)

(72) Inventor: Pascal JULE, TOURNEFEUILLE (FR)

(21) Appl. No.: 15/666,049

(22) Filed: Aug. 1, 2017

(30) Foreign Application Priority Data
Aug. 24, 2016 (FR) 16 57904

(51) Int. Cl. B64C 3/54; B64C 3/26

(52) U.S. Cl. CPC B64C 3/54; B64C 3/26

(57) ABSTRACT

An airfoil extension for a wing of an aircraft, the airfoil extension including an upper surface wall and a lower surface wall, the upper surface wall and the lower surface wall defining between them a profile of the airfoil extension. A structural reinforcement is disposed along the leading edge of the airfoil extension. The profile of the airfoil is configured to be modified in response to flight conditions (e.g., aerodynamic pressures acting on the upper surface wall and the lower surface wall) experienced by, on, and/or at the airfoil extension.

### CROSS-REFERENCE TO RELATED APPLICATION

This application claims the benefit of and priority to French patent application number 16 57904 filed on Aug. 24, 2016, the entire disclosure of which is incorporated by reference herein.

### TECHNICAL FIELD

The present disclosure relates to an airfoil extension for an aircraft wing, an aircraft wing comprising an airfoil extension of this kind, and also an aircraft comprising a wing of this kind.

### BACKGROUND

An aircraft traditionally comprises a fuselage, on each side of which a wing is fixed. In order to improve the drag of the aircraft, it is known in the art for the wings to be lengthened. This kind of lengthening results in excess weight for the aircraft due to the fact that different components have been added, such as the airfoil, the support structure of the airfoil, and the different actuators, for example. According to certain configurations, these different additions cancel out the gain achieved in terms of the drag.

### SUMMARY

An object of the present disclosure is to propose an airfoil extension that can change its profile and, in particular, its aerodynamic and mechanical characteristics in response to flight conditions.

To this end, an airfoil extension for an aircraft wing is disclosed, the airfoil extension comprising:

an upper surface wall;

a lower surface wall, wherein a profile of the airfoil extension is defined between the upper surface wall and the lower surface wall; and

a structural reinforcement disposed along the leading edge of the airfoil extension;

wherein the profile is configured to be modified in response to flight conditions experienced by the airfoil extension (e.g., aerodynamic pressures exerted thereon).

According to an embodiment, the upper surface wall comprises a first section which extends from the leading edge of the airfoil extension, and a second section which extends between the first section and the trailing edge of the airfoil extension, and the lower surface wall comprises a rigid section that extends from the trailing edge of the airfoil extension upstream and an extendable section which extends upstream from the rigid section.

According to another embodiment, the lower surface wall comprises a first section which extends from the leading edge of the airfoil extension, and a second section which extends between the first section and the trailing edge of the airfoil extension, and the upper surface wall comprises a rigid section that extends from the trailing edge of the airfoil extension upstream and an extendable section which extends upstream from the rigid section.

Advantageously, the second section exhibits a lower rigidity than that of the first section and the rigid section of the other wall.

According to one variant, the second section is produced using an elastomer material.

According to another variant, the second section is produced in a bilaminate material.

According to another variant, the airfoil extension comprises a deformable structure between the lower surface wall and the upper surface wall, the deformable structure being provided to flatten under the action of aerodynamic pressures acting on the upper surface wall and the lower surface wall.

Advantageously, the deformable structure exhibits at least two beams, a first beam exhibiting a first end fixed in an articulated manner to the structural reinforcement and a second end fixed in an articulated manner to the second section and to a first end of a second beam, the second end of the second beam being fixed in an articulated manner to the lower surface wall, and so on step by step, and each beam exhibits a length that diminishes when the temperature drops.

According to another variant, the airfoil extension comprises a beam fixed by one end to the structural reinforcement and by the other end to the trailing edge, and the beam exhibits a length that diminishes when the temperature drops.

The disclosure herein likewise discloses an aircraft wing, the wing comprising an airfoil extension according to one of the preceding variants mounted in sliding fashion on the inside of the wing.

The disclosure herein likewise proposes an aircraft comprising at least one wing according to the preceding variant.

### BRIEF DESCRIPTION OF THE DRAWINGS

The characteristics of the disclosure herein referred to above, as well as others, will appear more clearly on reading the following description of an exemplary embodiment, the description relating to the attached drawings, in which:

FIG. 1 shows a view from above of the aircraft according to the disclosure herein;

FIGS. 2 through 6 show sectional views of the airfoil extension along line II-II in FIG. 1 for different embodiments of the disclosure herein; and

FIG. 7 shows a sectional view of the airfoil extension along line II-II in FIG. 1 in two different positions for the embodiment in FIG. 3.

### DETAILED DESCRIPTION

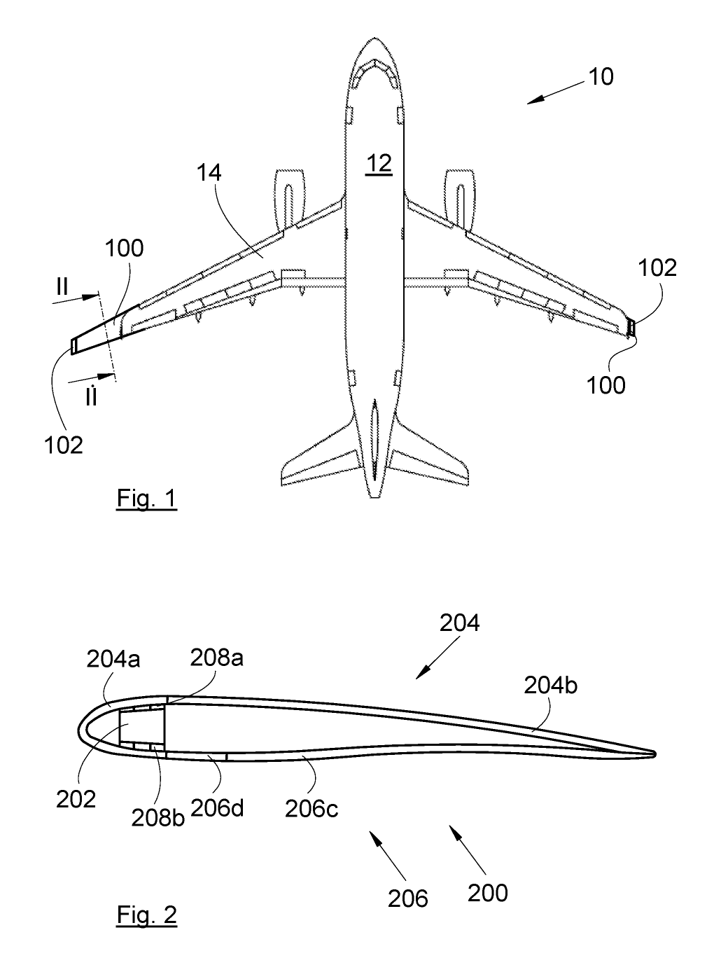

FIG. 1 shows an aircraft 10 which comprises a fuselage 12 to which a wing 14 is fixed on either side. Traditionally, during the course of an aircraft 10 flight there are different phases, such as take-off, the cruising phase, and landing. The aerodynamic characteristics to be implemented are different for each of these phases.

Each wing 14 is equipped with an airfoil extension 100 which is mounted in sliding fashion on the inside of the wing 14 and which may, alternatively, adopt a retracted position (on the starboard side in FIG. 1) or in an extended position (on the port side in FIG. 1).

Each airfoil extension 100 is mounted in telescopic fashion on the inside of the wing 14, which is equipped with a displacement actuator to make the airfoil extension 100 move between and including the retracted position and the extended position. The displacement actuator can, in some embodiments, include devices such as cylinders or motors.

In the embodiment of the disclosure herein depicted in FIG. 1, the airfoil extension 100 is equipped with a winglet 102 at its free end, but the disclosure herein can likewise be applied to an airfoil extension without a winglet.

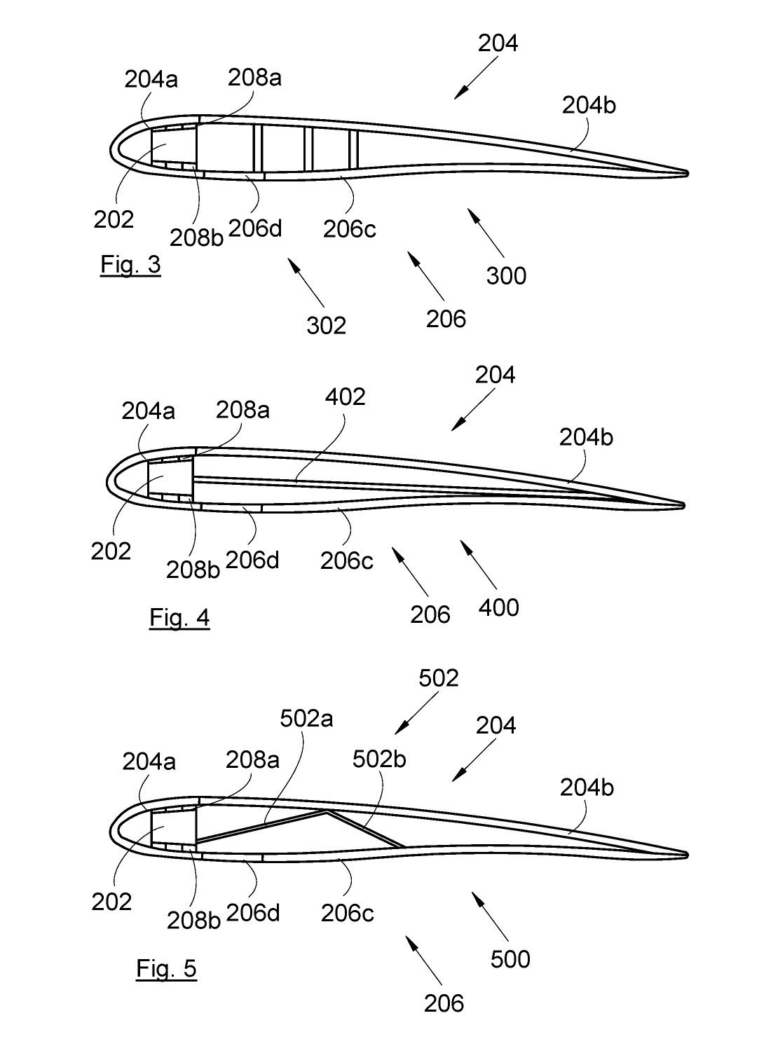

In the different embodiments which are described in relation to FIGS. 2 through 7, the airfoil extensions 200, 300, 400, 500 and 600 exhibit an upper surface wall 204 and a lower surface wall 206 which between them define a profile of the airfoil extension. The airfoil extensions likewise exhibit a structural reinforcement 202 disposed along the leading edge of the airfoil extension 200, 300, 400, 500, 600. The profile of each airfoil extension takes the shape of a wing profile.

In the embodiment of the disclosure herein depicted in FIGS. 2 through 7, the structural reinforcement 202 takes the shape of a longeron disposed between the upper surface wall 204 and the lower surface wall 206 just downstream and along the leading edge of the airfoil extension, but it may take another shape such as, for example, that of a local reinforcement of the structure of the leading edge. In the same way, the structural reinforcement 202 in this case exhibits a rectangular section, but it may take on other forms such as, for example, a Z section to absorb more changes to the profile.

In each embodiment, the airfoil extension 200, 300, 400, 500, 600 is configured to modify its profile in response to the flight conditions (e.g., aerodynamic pressures acting on the surfaces thereof) of the aircraft 10 and, therefore, also of the airfoil extension 200, 300, 400, 500, 600. Changes to the profile of the airfoil extension 200, 300, 400, 500, 600 relate, in particular, to the aerodynamic and mechanical characteristics of the airfoil extension, such as its profile and, more particularly, the curvature and thickness of the profile.

The aerodynamic center of lift of the airfoil extension 200, 300, 400, 500, 600 is downstream of the structural torsional center of the airfoil extension 200, 300, 400, 500, 600.

In particular, the airfoil extension 200, 300, 400, 500, 600 exhibits a first profile which is used during the cruising phase of a flight and which is rigid, and a second profile which is used during other phases of the flight, such as take-off and landing, and which is rigid but deformed in respect of the first profile with a change to the curve and the thickness of the airfoil extension, so as to reduce the airfoil incidence locally, in other words, the angle between the air flow and the leading edge/trailing edge direction, and therefore to allow the relieving of stresses through rotation of the airfoil extension, the structure whereof no longer needs to be reinforced.

The airfoil extension 200, 300, 400, 500, 600 is configured to maintain the rigidity of the profile during the different phases of flight of the aircraft 10, while allowing for a deformation between two rigid forms outside the cruising phase. In particular, the deformation involves an increase in flexibility, allowing stresses to which the airfoil extension 200, 300, 400, 500, 600 is subjected when in contact with the air flow to be released. The sought-after increased flexibility depends on the stresses at the airfoil extension 200, 300, 400, 500, 600 transmitted towards the center of the wing 14 and, therefore, the incidence of the wing 14 and of the structure of the aircraft 10.

This increased flexibility is accompanied by a change in the curvature and a bringing together of the upper surface wall 204 and the lower surface wall 206 (e.g., a compression towards each other).

In each of the embodiments depicted in FIGS. 1 through 5 and 7, the upper surface wall 204 comprises a first section 204a which extends from the leading edge of the airfoil extension downstream, by up to one third overall before the upper surface wall 204, which corresponds in this case to the downstream section of the structural reinforcement 202, and a second section 204b between the first section 204a and the trailing edge of the airfoil extension.

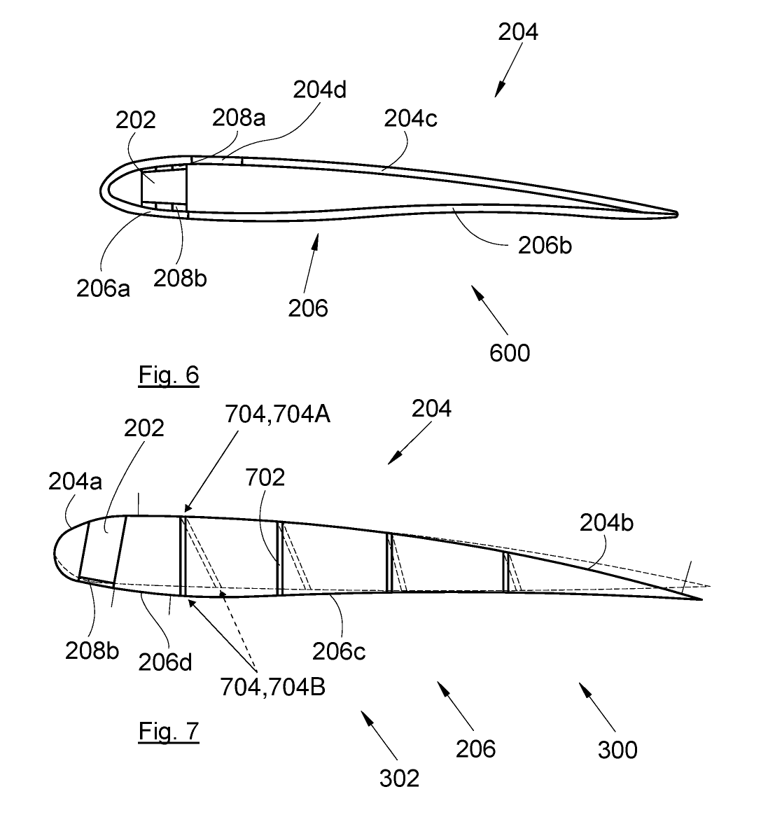

In each of the embodiments depicted in FIGS. 1 through 5 and 7, the lower surface wall 206 comprises a rigid section 206c which extends from the trailing edge of the airfoil extension upstream, by up to one third overall before the lower surface wall 206 and an extendable silicon-type section 206d which extends upstream from the rigid section 206c, in this case the extendable section 206d extends up to the downstream section of the structural reinforcement 202. As has been shown more particularly in FIG. 7, the change in the profile leads to lengthening of the lower surface wall 206 which is possible due to the presence of the extendable section 206d.

In each of the embodiments depicted in FIGS. 1 through 5 and 7, the first section 204a and the rigid section 206c are produced in a rigid material such as, for example, a metal or plastic material or another material, such as carbon or aluminum.

The second section 204b exhibits a lower rigidity than that of the first section 204a and the rigid section 206c of the other wall, in this case the lower surface wall 206, and is produced using elastomer resin with fiber reinforcements, for example.

FIG. 2 shows the airfoil extension 200 according to a first embodiment in which the structural reinforcement 202 is fixed to the profile by fasteners 208a-b.

According to a first variant, the second section 204b may be produced using an elastomer material, such as silicon, which is subject to movements caused by the kinematics of the other movable elements.

According to a second variant, the second section 204b may be realized in a bilaminate material which exhibits two stable positions and which requires the application of stress to the bilaminate material, in order to move from one position to the other. A bilaminate material comprises two plates fixed one on the other and produced using materials with different rigidities. It may, for example, be an aluminum or fiberglass sheet on a carbon skin structure. The gap between these two plates may be left empty or filled with intermediate elements, such as elastomers.

Hence, according to the stresses exerted on the second section 204b, two stable positions can be obtained, for example a position that conforms to that represented in FIG. 2 and a position in which the second section 204b is retracted further and is therefore closer to the lower surface wall 206.

FIG. 3 shows the airfoil extension 300 according to a second embodiment in which the structural reinforcement 202 is fixed to the profile by fasteners 208a-b.

The second section 204b may be produced using an elastomer material or a bilaminate material or any material that is sufficiently flexible to allow a degree of deformation without being damaged.

Between the lower surface wall 206 and the upper surface wall 204 is arranged a deformable structure 302 provided to be flattened under the action of aerodynamic pressure applied to the upper surface wall 204 and the lower surface wall 206.

The deformable structure 302 has, for example, a so-called “double ball joint” comprising rigid structural elements articulated about flexible articulations outside the cruising phase, in other words, with a low incidence and/or low loads.

FIG. 7 shows the airfoil extension 300 in a first position in solid lines and in a second position in dotted lines. The deformable structure 302 in this case takes the shape of a plurality of connecting rods 702 which are parallel. Each end of each rod 702 is rotatably articulated on a respective joint 704, such as a ball joint, a first joint 704A (e.g., a first ball joint) of which is, in some embodiments, connected to and/or integral with (e.g., formed in a single piece with) the lower surface wall 206, and more particularly to the rigid section 206c, and a second joint 704B (e.g., a second ball joint) of which is, in some embodiments, connected to and/or integral with (e.g., formed in a single piece with) the upper surface wall 204, more particularly the second section 204b. The deformable structure 302 remains rigid (e.g., is in a first position) when the pressure which is exerted is parallel to the rods 702 and the deformable structure 302 is flattened into the shape of a parallelogram (e.g., moves towards and/or to a second position) when the pressure which is applied is non-parallel to the deformable structure 302 and/or the plurality of connecting rods 702. The pressure is due to the aerodynamic pressure on the upper surface wall 204 and the lower surface wall 206. The flattening of the deformable structure 302 brings the upper surface wall 204 and the lower surface wall 206 closer together (e.g., a distance between the lower surface wall and the upper surface wall decreases).

FIG. 4 shows the airfoil extension 400 according to a third embodiment in which the structural reinforcement 202 is fixed to the profile by fasteners 208a-b.

The second section 204b may be produced using an elastomer material or a bilaminate material or any material which is flexible enough to allow a certain amount of deformation without being damaged.

The airfoil extension 400 likewise exhibits a beam 402 fixed by one end to the structural reinforcement 202 and by the other end to the trailing edge.

The beam 402 is fixed to the structural reinforcement 202 by a flexible or articulated link.

The beam 402 is fixed to the trailing edge by a flexible or articulated link to the second section 204b or to the lower surface wall 206 or to both.

The beam 402 exhibits the property of changing length in response to its environment, causing a thinning or a widening of the airfoil extension 400, as the case may be.

The beam 402 may be realized in a bilaminate material, the length of which changes according to the stresses to which it is exposed due to aerodynamic pressures on the upper surface wall 204 and the lower surface wall 206.

The beam 402 can be realized in a shape memory material, the length of which changes in response to the ambient temperature, and in which the length diminishes when the temperature drops.

FIG. 5 shows the airfoil extension 500 according to a fourth embodiment in which the structural reinforcement 202 is fixed to the profile by fasteners 208a-b.

The second section 204b can be produced using an elastomer material or in a bilaminate material or any material that is flexible enough to allow a certain amount of deformation without being damaged.

The airfoil extension 500 likewise exhibits a deformable structure 502 provided to be flattened under the action of aerodynamic pressures acting on the upper surface wall 204 and the lower surface wall 206.

The deformable structure 502 comprises two beams 502a-b. A first beam 502a exhibits a first end fixed in an articulated manner to the structural reinforcement 202 and a second end fixed in an articulated manner to the second section 204b and to a first end of a second beam 502b. The second end of the second beam 502b is fixed in an articulated manner to the lower surface wall 206.

It is possible to have more than two beams 502a-b, the articulated fixing of the beams is then effected step by step, one after the other, with an articulated fixing to the second section 204b and to the lower surface wall 206 being alternated.

The beams 502a-b exhibit the property of changing length in response to their environment, which causes a thinning or widening of the airfoil extension 500, as the case may be.

Each beam 502a-b may be produced using a bilaminate material, the length of which changes according to the stresses to which it is exposed due to pressures on the upper surface wall 204 and the lower surface wall 206.

Each beam 502a-b may be realized in a shape memory material, the length of which changes in response to the ambient temperature, and in which the length diminishes when the temperature drops.

In the embodiment shown in FIG. 6, the lower surface wall 206 comprises a first section 206a which extends from the leading edge of the airfoil extension downstream, by up to one third overall before the lower surface wall 206, which corresponds in this case to the downstream section of the structural reinforcement 202, and a second section 206b between the first section 206a and the trailing edge of the airfoil extension. The upper surface wall 204 comprises a rigid section 204c which extends from the trailing edge of the airfoil extension upstream, by up to one third overall before the upper surface wall 204, and an extendable section 204d of the silicon type which extends upstream from the rigid section 204c, in this case the extendable section 204d extends to the downstream section of the structural reinforcement 202.

The first section 206a and the rigid section 204c are produced using a rigid material, such as, for example, a metal or plastic material or another material such as carbon or aluminum.

The second section 206b exhibits a lower rigidity than that of the first section 206a and the rigid section 204c of the other wall, in this case the upper surface wall 204, and is produced using elastomer resin with fiber reinforcements, for example.

FIG. 6 shows the airfoil extension 600 in which the structural reinforcement 202 is fixed to the profile by fasteners 208a-b.

Moreover, FIG. 6 takes on the structure described in FIG. 2, in other words the second section 206b can be produced using an elastomer material or a bilaminate material. However, the airfoil extension 600 may take on the same structures as those described in FIGS. 3 to 5, with the first section and the second section influencing the lower surface wall and not the upper surface wall.

In the different embodiments shown, the structural reinforcement 202 takes the shape of a beam, or longeron, but these different embodiments are applied in the same manner in the case of a local reinforcement of the structure of the leading edge.

In the different embodiments shown, the structural reinforcement 202 is fixed both to the upper surface wall 204 and to the lower surface wall 206. According to different embodiments, however, it is possible for the structural reinforcement 202 to be fixed only to the upper surface wall 204 or to the lower surface wall 206.

The fasteners 208a-b are, in some embodiments, based on screw components and can comprise, for example, a rigid element guaranteeing integrity in terms of safety and a flexible element to absorb changes in the profile. The fasteners 208a-b may take the shape of metal elements, which pass through the airfoil extension 200, 300, 400, 500, and 600 with play, and silicon components. The metal components are configured to only be utilized in the event that the silicon components should fail.

In all embodiments presented here, the structural reinforcements used have a low impact on the weight of the aircraft. Hence, the aircraft's drag is improved without having to increase the weight of the aircraft.

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An airfoil extension for a wing of an aircraft, the airfoil extension comprising:
an upper surface wall;
a lower surface wall, wherein a profile of the airfoil extension is defined between the upper surface wall and the lower surface wall;
a structural reinforcement disposed along a leading edge of the airfoil extension; and
a deformable structure arranged between the lower surface wall and the upper surface wall, wherein the deformable structure is configured to flatten, at least partially, under an action of aerodynamic pressures acting on the upper surface wall and the lower surface wall during flight,
wherein the profile is configured to be modified in response to flight conditions experienced by the airfoil extension.

2. The airfoil extension of claim 1, wherein the upper surface wall comprises a first section, which extends downstream from the leading edge of the airfoil extension, and a second section, which extends between the first section and a trailing edge of the airfoil extension, and wherein the lower surface wall comprises a rigid section, which extends upstream from the trailing edge of the airfoil extension, and an extendable section, which extends upstream from the rigid section.

3. The airfoil extension of claim 2, wherein the second section has a rigidity that is less than a rigidity of the first section and the rigid section of the lower surface wall.

4. The airfoil extension of claim 2, wherein the second section comprises an elastomer material.

5. The airfoil extension of claim 2, wherein the second section comprises a bilaminate material.

6. The airfoil extension of claim 2, wherein the deformable structure comprises at least two beams, a first beam and a second beam, wherein a first end of the first beam is fixed in an articulated manner to the structural reinforcement, wherein a second end of the first beam is fixed in an articulated manner to the second section and also to a first end of the second beam, wherein a second end of the second beam is fixed in an articulated manner to the lower surface wall, and wherein each beam has a length that decreases as a temperature thereof decreases.

7. The airfoil extension of claim 2, comprising a beam, wherein a first end of the beam is fixed to the structural reinforcement, wherein a second end of the beam is fixed to the trailing edge, and wherein the beam has a length that decreases as a temperature of the beam decreases.

8. The airfoil extension as claimed in claim 1, wherein the lower surface wall comprises a first section, which extends downstream from the leading edge of the airfoil extension, and a second section, which extends between the first section and the trailing edge of the airfoil extension, and wherein the upper surface wall comprises a rigid section, which that extends upstream from the trailing edge of the airfoil extension, and an extendable section, which extends upstream from the rigid section.

9. The airfoil extension of claim 8, wherein the second section has a rigidity that is less than a rigidity of the first section and the rigid section of the upper surface wall.

10. The airfoil extension of claim 8, wherein the second section comprises an elastomer material.

11. The airfoil extension of claim 8, wherein the second section comprises a bilaminate material.

12. The airfoil extension of claim 8, wherein the deformable structure comprises at least two beams, a first beam and a second beam, wherein a first end of the first beam is fixed in an articulated manner to the structural reinforcement, wherein a second end of the first beam is fixed in an articulated manner to the second section and also to a first end of the second beam, wherein a second end of the second beam is fixed in an articulated manner to the lower surface wall, and wherein each beam has a length that decreases as a temperature thereof decreases.

13. The airfoil extension of claim 8, comprising a beam, wherein a first end of the beam is fixed to the structural reinforcement, wherein a second end of the beam is fixed to the trailing edge, and wherein the beam has a length that decreases as a temperature of the beam decreases.

14. The airfoil extension of claim 1, wherein the deformable structure comprises a plurality of connecting rods.

15. The airfoil extension of claim 14, wherein each respective connecting rod of the plurality of connecting rods is oriented parallel with each other and comprises a first end and a second end.

16. The airfoil extension of claim 15, wherein the first end of each respective connecting rod is rotatably articulated on a first joint that is connected to the lower surface wall, and wherein the second end of each respective connecting rod is rotatably articulated on a second joint that is connected to the upper surface wall.

17. The airfoil extension of claim 16, wherein the first and second joints are ball joints, wherein the first joint is integral with the lower surface wall, and wherein the second joint is integral with the upper surface wall.

18. The airfoil extension of claim 14, wherein the deformable structure is configured, when the aerodynamic pressure exerted on the airfoil extension is oriented parallel to the plurality of connecting rods, to remain in a first position and, when the aerodynamic pressure exerted on the airfoil extension is oriented non-parallel to the plurality of connecting rods, to move from the first position towards a second position, and wherein a distance between the lower surface wall and the upper surface wall decreases as the plurality of connecting rods move from the first position towards the second position.

19. A wing of an aircraft comprising an airfoil extension according to claim 1, wherein the airfoil extension is mounted to the wing in sliding fashion on an inside of the wing.

20. An aircraft comprising at least one wing according to claim 19.
